(19) United States
(12) Patent Application Publication
(10) Pub. No.: US 2021/0270459 A1
(43) Pub. Date: Sep. 2, 2021

(54) GAS FIRED RADIANT EMITTER COMPRISING A RADIANT SCREEN

(71) Applicant: SOLARONICS, ARMENTIERES (FR)

(72) Inventors: Nicolas EVEN, VIEILLE CHAPELLE (FR); James FARINHA, STAZEELE (FR); Eddy VERHEYDE, ENNETIERES EN WEPPES (FR)

(21) Appl. No.: 17/261,251

(22) PCT Filed: Jul. 9, 2019
(86) PCT No.: PCT/EP2019/068316

§ 371 Date: Jan. 19, 2021

(30) Foreign Application Priority Data
Jul. 20, 2018 (EP) 18290085.2

(51) Int. Cl. F23D 14/14

(52) U.S. Cl. CPC F23D 14/147; F23D 14/02; F23D 14/145

(57) ABSTRACT

A gas fired radiant emitter comprises a burner deck onto which premix gas is combusted when the emitter is in use; and a metal plate provided at the combustion side of the burner deck. The metal plate is provided to act as radiant screen when the emitter is in use. The metal plate is at least over part of its surface spaced from the burner deck. The metal plate comprises a plurality of elongated slots for passage through the metal plate of flue gas generated on the burner deck. The plurality of elongated slots comprise a first elongated slot. The first elongated slot has a first tangent along a position along the length of the first elongated slot. The plurality of elongated slots comprise a second elongated slot. The second elongated slot has a second tangent along a position along the length of the second elongated slot. The angle between the first tangent and the second tangent is between 45° and 135°.

### TECHNICAL FIELD

The present disclosure relates to gas fired radiant emitters as are used for heating continuously moving substrates such as paper, board or metal strip. The gas fired radiant emitter of the disclosure comprises an improved radiant screen.

### BACKGROUND ART

Gas fired radiant emitters comprising a ceramic burner plate and one or two radiant screens distanced from the ceramic burner plate are known. Typically, parallel ceramic bars or woven wire mesh screens are used as radiant screen. WO2010/003904A1 shows an example of such gas fired radiant emitter.

U.S. Pat. No. 3,847,536 discloses a gas fired radiant emitter comprising a perforated metal radiant screen and a more distant screen made of woven refractory metal wire.

### SUMMARY

The first aspect of the present disclosure is a gas fired radiant emitter. The gas fired radiant emitter comprises a burner deck onto which premix gas is combusted when the emitter is in use; and a metal plate provided at the combustion side of the burner deck. The metal plate is provided to act as radiant screen when the emitter is in use. The metal plate is at least over part of its surface for example over its full surface—spaced from the burner deck. The metal plate comprises a plurality of elongated slots for passage through the metal plate of flue gas generated on the burner deck. The plurality of elongated slots comprise a first elongated slot. The first elongated slot has a first tangent along a position along the length of the first elongated slot. The plurality of elongated slots comprise a second elongated slot. The second elongated slot has a second tangent along a position along the length of the second elongated slot. The angle between the first tangent and the second tangent is between 45° and 135°, or between 75° and 105°. With “first and second elongated slots” is not meant a numbering order, but rather to differentiate two different elongated slots. With “first tangent and second tangent” is not meant a numbering order of any kind, but rather to differentiate the tangent one from the other for explanation purposes.

The slots on the metal plate may create interruptions to the conduction of heat over the surface of the metal plate. Therefore, the borders of the metal plate may be cooler. Consequently, a more simple way of fixation of the metal plate into the gas fired radiant emitter can be used. Less or even no insulation material may be required in this fixation. As the borders of the metal plate may be cooler, less heat may be lost via conduction through the fixation of the metal plate, possibly resulting in a higher efficiency of the radiant emitter.

It may be possible that the percentage of perforated area of the metal plate can be designed, by the selection and positioning of the elongated slots. The percentage of perforated area of the metal plate can be designed to be low, for high efficiency of radiation of the metal plate. The percentage of perforated area can also be optimized as a function of the power (in kW/m² of surface area) of the emitter.

Optionally, a plurality of the plurality of the elongated slots have the same shape and length as the first elongated slot; and a plurality of the plurality of elongated slots have the same shape and length as the second elongated slot.

Optionally, the plurality of elongated slots comprises a third elongated slot. The third elongated slot has a third tangent along a position along its length. The plurality of elongated slots comprises a fourth elongated slot. The fourth elongated slot has a fourth tangent along a position along its length. The angle between the third tangent and the fourth tangent is between 45° and 135°, or between 75° and 105°. The third elongated slot differs in shape and/or in length from the first and the second elongated slot. The fourth elongated slot differs in shape and/or in length from the first, the second and the third elongated slot. Optionally, a plurality of the plurality of the elongated slots have the same shape and length as the third elongated slot; and a plurality of the plurality of elongated slots have the same shape and length as the fourth elongated slot. With “third and fourth elongated slots” is not meant a numbering order, but rather to differentiate two different elongated slots. With “third tangent and fourth tangent” is not meant a numbering order of any kind, but rather to differentiate the tangent one from the other for explanation purposes.

Optionally, at least part of the elongated slots are selected from one or more of U-shape, L-shape or a continuously bent shape.

Optionally, at least part of the elongated slots have a shape such that the shape has an opening. A plurality of the elongated slots are arranged such that the opening of the shape of an elongated slot of the plurality of the elongated slots faces the opening of the shape of an immediately neighbouring elongated slot of the plurality of the elongated slots.

Optionally, the metal plate comprises at its centre a rectangle of at least 7%—or at least 10%—of the surface of the burner deck. The percentage of open area of the rectangle is less than the average of the percentage of open area of the metal plate outside the rectangle. When the gas fired radiant emitter is in use, the metal plate is hotter at its central section than outside its central section. The smaller percentage of open area of the rectangle provided in the centre of the metal plate may facilitate coping of the metal plate with the stresses caused by the thermal expansion of the metal. This way, formation of cracks in the central section of the metal plate may be prevented more efficiently, possibly resulting in a radiant emitter of long lifetime.

Optionally, the total open area of the elongated slots of the metal plate is less than 12% of the surface of the metal plate. With “open area” is meant the accumulated area of the elongated slots of the metal plate. This configuration may allow use of a radiant screen with low perforated (or open) area, which may be beneficial for the radiant efficiency of the radiant screen.

Optionally, the radiant screen comprises a coating to increase its radiation emissivity and/or to increase its thermal conductivity.

Optionally, the metal plate is flat.

Optionally, the metal plate is bent. Optionally, the metal plate has a rectangular shape and the metal plate is flat in its middle section and bent at two of the sides of the rectangular shape.

Optionally, the burner deck comprises a ceramic burner plate comprising a plurality of perforations for flow of premix gas; or the burner deck comprises metal fibers or a metal wire mesh.

Optionally, the burner deck comprises two ceramic plates positioned next to each other, optionally with a joint in between.

Optionally, the fixation of the metal plate into the gas fired radiant emitter is such that the metal plate is fixed with play relative to the fixation parts. This way, thermal expansion and retraction of the metal plate may be possible. Such embodiments may provide emitters with longer lifetime.

Optionally, the metal plate is retained into the radiant emitter by one or a plurality of retainer bars positioned over and/or below and/or through the metal plate. Optionally, ends of the one or a plurality of retainer bars are positioned through slots in retainer elements of the frame of the radiant emitter. Optionally, the one or a plurality of retainer bars contain a hook. The hook grabs through slots in the metal plate to support the bars in retaining the metal plate into the radiant emitter. Optionally, the metal plate comprises retainer slots along two of its sides. The retainer elements of the frame of the radiant emitter are slid through the retainer slots of the metal plate or one or a plurality of retainer bars are slid through the retainer slots. Such embodiments may provide emitters that are easy to assemble and that have a long lifetime. In such embodiments, thermal expansion and retraction of the metal plate may be possible.

Optionally, the burner deck has a rectangular shape with two parallel long sides and two parallel shorter sides. Optionally, along the long sides, open areas are provided between the burner deck and the metal plate such that flue gas can flow out between the burner deck and the metal plate. Such emitters can be made cheaper, as less parts are required and assembly is facilitated. When such emitters are positioned in a heat treatment installation in a row of emitters, with the long sides of the burner deck parallel and next to each other, further benefits may be obtained. There is reduced discontinuity between neighbour emitters, possibly resulting in a more uniform emission of radiation from the row of emitters. Furthermore, ignition and flame propagation over the row of emitters may be facilitated. Optionally, insulating elements are positioned along the short sides between the burner deck and the metal plate. A sealing element can be provided along the short sides such that no flue gas produced by the burner deck can flow out at the short side between the burner deck and the metal plate. As in such embodiments no flue gas can flow out along the short sides, no heat is lost along the short sides, possibly resulting in an emitter with increased efficiency. The sealing element can be provide by a plurality e.g. a plurality of layers of metal elements. Optionally, the metal elements have the ability to move. The metal elements can be mounted via a hooks and slots.

The metal plate optionally comprises a section with increased porosity compared to outside this section. With “porosity” is meant the surface of the elongated slots in a section of the metal plate as a percentage of the surface of that section. At the non-combustion side of the metal plate, an ignition device or a sensor is provided at the section with increased porosity. Optionally, the section with increased porosity is provided within a circular area having less than 3.5 cm diameter. When an ignition device is provided at this section of the metal plate, ignition of the gas fired radiant emitter may be facilitated. When a sensor is provided at the section with increased porosity, flame sensing flame detection of flame quality control may be facilitated.

The second aspect of the present disclosure is an apparatus for the heat treatment of continuously moving strip material. Examples of such heat treatment are drying and curing, e.g. of coatings applied on continuously moving strip material. The strip material can e.g. be paper, board or metal strip. The apparatus comprises a plurality of gas fired radiant emitters as in any embodiments of the first aspect of the present disclosure. The gas fired radiant emitters are provided for heat treatment by IR-radiation of the continuously moving strip material.

Optionally, a plurality of gas fired radiant emitters are installed parallel to each other over the width of the apparatus for treatment of moving strip material; with the long sides of the burner decks aligned with the direction of movement of the strip material; and with a small slot between the long sides of neighbouring metal plates. There may be reduced discontinuity between neighbour emitters, possibly resulting in a more uniform emission of radiation from the apparatus for heat treatment. Furthermore, ignition and flame propagation over the row of emitters may be facilitated thanks to the open area between the burner decks and the metal plates of the emitters.

### BRIEF DESCRIPTION OF FIGURES IN THE DRAWINGS

FIG. 1 shows a gas fired radiant emitter according to the present disclosure.

FIG. 2 shows a metal plate which can be used in emitters according to the present disclosure for acting as radiant screen.

FIG. 3 shows an example of an apparatus according to the second aspect of the present disclosure.

FIG. 4 shows a gas fired radiant emitter according to the present disclosure.

### DETAILED DESCRIPTION

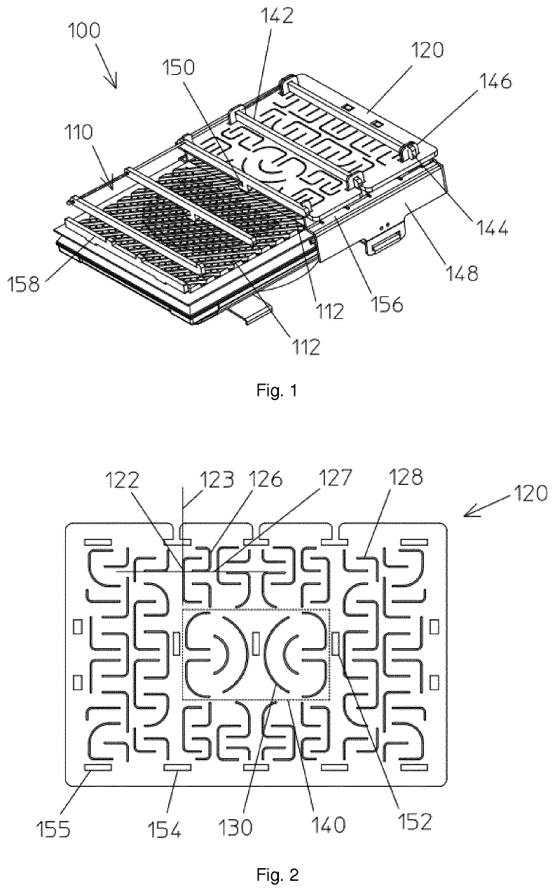

FIG. 1 shows an example of a gas fired radiant emitter 100 according to the present disclosure. The gas fired radiant emitter comprises a burner deck 110 onto which premix gas is combusted when the emitter is in use; and a flat metal plate 120 provided at the combustion side of the burner deck. In FIG. 1, the metal plate is taken away over half of the burner deck, to illustrate the different parts of the gas fired radiant emitter. The metal plate is spaced from the burner deck. The metal plate is shown in full in FIG. 2.

The burner deck comprises two ceramic burner plates 112 each comprising a plurality of perforations for flow of premix gas. The two ceramic plates are positioned next to each other with a joint in between. When the emitter is in use, premix gas flows from the back of the burner plates, through its perforations, to be combusted on the burner plates at the side where the metal plate is provided. The metal plate will become hot by radiation from the burner plates and by the flue gas flow. The metal plate is provided to act as radiant screen: it will radiate heat to the object to be heated.

The metal plate 120 (see FIGS. 1 and 2) comprises a plurality of elongated slots 122, 126, 128, 130 for passage through the metal plate of flue gas generated on the burner deck. Part of the elongated slots have a U-shape (122, 126), L-shape (128) or a continuously bent shape (130).

The plurality of elongated slots comprise a first elongated slot 122. The first elongated slot has a first tangent 123 along a position along the length of the first elongated slot. The plurality of elongated slots comprise a second elongated slot 126. The second elongated slot has a second tangent 127 along a position along the length of the second elongated slot. The angle between the first tangent and the second tangent is 90°. A plurality of the plurality of the elongated slots have the same shape and length as the first elongated slot. A plurality of the plurality of elongated slots have the same shape and length as the second elongated slot.

A plurality of the elongated slots are arranged such that the opening of the shape of an elongated slot faces the opening of the shape of an immediately neighbouring elongated slot of the plurality of the elongated slots, see e.g. elongated slots 122 and 126.

The metal plate comprises in the central rectangle in FIG. 2 indicated with dashed lines 140—having 14% of the surface of the burner deck a percentage of open area of the rectangle less than the average of the percentage of open area of the metal plate outside the rectangle.

The total open area of the elongated slots of the metal plate is 8%. With “open area” is meant the accumulated area of the elongated slots of the metal plate. The present disclosure allows to use a radiant screen with low perforated (or open) area, which is beneficial for the radiant efficiency of the radiant screen.

The metal plate is retained into the radiant emitter by a plurality of retainer bars 142 positioned over the metal plate. Ends of the retainer bars are positioned through slots 144 in retainer elements 146 of the frame 148 of the radiant emitter. The retainer bars contain a hook 150, which grabs through slots 152 in the metal plate to support the bars in retaining the metal plate into the radiant emitter. The metal plate comprises retainer slots 154 along two of its sides. The retainer elements 146 of the frame of the radiant emitter are slid through the retainer slots of the metal plate. This way, the emitter can be easily assembled and has a long lifetime, as the fixation of the metal plate into the gas fired radiant emitter is such that the metal plate is fixed with play. Thermal expansion and retraction is possible of the metal plate relative to the fixation parts.

The burner deck can comprise retainer slots 155, which are larger than the other retainer slots 154. The larger retainer slots 155 can contribute to the holding of an insulating element 158 (e.g. a U-shaped insulating element) at the short side of the rectangular gas fired radiant emitter. A benefit is easy assembly of the insulation in the gas fired radiant emitter.

The burner deck has a rectangular shape with two parallel long sides and two parallel shorter sides. Along the long sides, open areas 156 are provided between the burner deck and the metal plate such that flue gas can flow out between the burner deck and the metal plate. Insulating elements 158 are positioned along the short sides between the burner deck and the metal plate. A sealing element is provided along the short sides such that no flue gas produced by the burner deck can flow out at the short side between the burner deck and the metal plate.

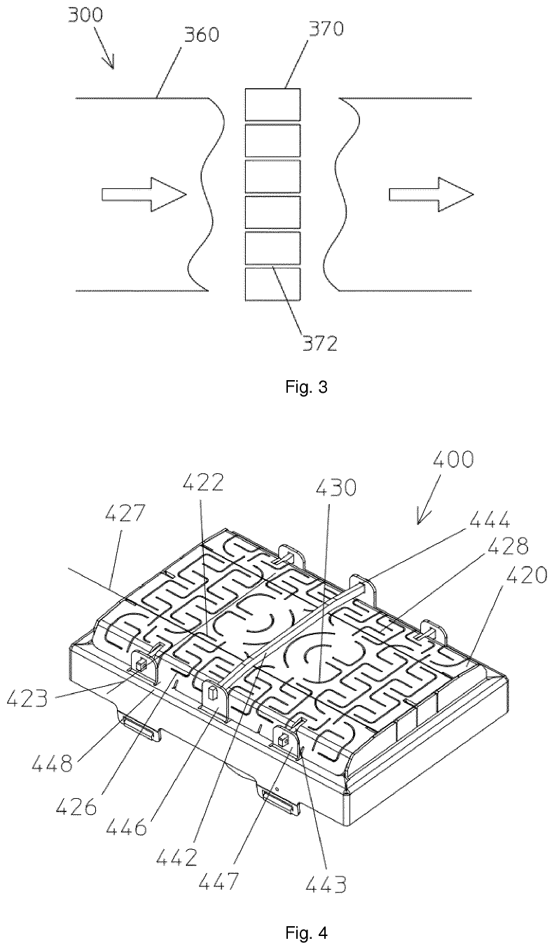

FIG. 3 shows an example of an apparatus 300 according to the second aspect of the present disclosure. The apparatus is provided for the heat treatment of continuously moving strip material 360. The apparatus is equipped with a plurality of gas fired radiant emitters 370 according to the present disclosure. The gas fired radiant emitters heat the bottom of the moving strip material via infrared radiation. In order to show the emitters, part of the continuously moving strip material is cut away in FIG. 3. The plurality of gas fired radiant emitters are installed parallel to each other over the width of the apparatus for treatment of moving strip material. The long sides of the burner decks are aligned with the direction of movement of the strip material. Small slots 372 are provided between the long sides of neighbouring metal plates.

FIG. 4 shows an example of a gas fired radiant emitter 400 according to the present disclosure. The gas fired radiant emitter comprises a burner deck (not visible in FIG. 4, but similar to the burner deck of the gas fired radiant emitter of FIG. 1) onto which premix gas is combusted when the emitter is in use; and a metal plate 420 provided at the combustion side of the burner deck. The metal plate has a rectangular shape. The metal plate is flat in its middle section and bent at two of the sides of the rectangular shape. The metal plate is provided to act as radiant screen: it will radiate heat to the object to be heated.

The metal plate 420 comprises a plurality of elongated slots 422, 426, 428, 430 for passage through the metal plate of flue gas generated on the burner deck. Part of the elongated slots have a U-shape (422, 426), L-shape (428) or a continuously bent shape (130).

The plurality of elongated slots comprise a first elongated slot 422. The first elongated slot has a first tangent 423 along a position along the length of the first elongated slot. The plurality of elongated slots comprise a second elongated slot 426. The second elongated slot has a second tangent 427 along a position along the length of the second elongated slot. The angle between the first tangent and the second tangent is 90°. A plurality of the plurality of the elongated slots have the same shape and length as the first elongated slot. A plurality of the plurality of elongated slots have the same shape and length as the second elongated slot.

A plurality of the elongated slots are arranged such that the opening of the shape of an elongated slot faces the opening of the shape of an immediately neighbouring elongated slot of the plurality of the elongated slots, see e.g. elongated slots 122 and 126.

The total open area of the elongated slots of the metal plate is 8%. With “open area” is meant the accumulated area of the elongated slots of the metal plate. The present disclosure allows to use a radiant screen with low perforated (or open) area, which is beneficial for the radiant efficiency of the radiant screen.

The metal plate is retained into the radiant emitter by a retainer bars 442 positioned over the metal plate. The ends of the retainer bar are positioned through slots 444 in retainer elements 446 of the frame 448 of the radiant emitter. The metal plate is also retained into the radiant emitter by retainer bars 443 slid through retainer slots in the metal plate provided for this purpose; the ends of these retainer bars 443 are slid through slots in retainer elements 447 of the frame 448 of the radiant emitter.

1. A gas fired radiant emitter, comprising
a burner deck onto which premix gas is combusted when the emitter is in use; and
a metal plate provided at the combustion side of the burner deck, for acting as radiant screen;
wherein the metal plate is at least over part of its surface spaced from the burner deck;
wherein the metal plate comprises a plurality of elongated slots for passage through the metal plate of flue gas generated on the burner deck;
wherein the plurality of elongated slots comprise a first elongated slot, wherein the first elongated slot has a first tangent along a position along its length;
wherein the plurality of elongated slots comprise a second elongated slot, wherein the second elongated slot has a second tangent along a position along its length;
wherein the angle between the first tangent and the second tangent is between 45° and 135°.

2. The gas fired radiant emitter as in claim 1, wherein at least part of the elongated slots are selected from one or more of U-shape, L-shape or a continuously bent shape.

3. The gas fired radiant emitter as in claim 1,
wherein at least part of the elongated slots have a shape such that the shape has an opening,
wherein a plurality of the elongated slots are arranged such that the opening of the shape of an elongated slot of the plurality of the elongated slots faces the opening of the shape of an immediately neighbouring elongated slot of the plurality of the elongated slots.

4. The gas fired radiant emitter as in claim 1,
wherein the metal plate comprises at its centre a rectangle of at least 7% of the surface of the burner deck,
wherein the percentage of open area of the rectangle is less than the average of the percentage of open area of the metal plate outside the rectangle.

5. The gas fired radiant emitter as in claim 1, wherein the total open area of the elongated slots of the metal plate is less than 12% of the surface of the metal plate.

6. The gas fired radiant emitter as in claim 1, wherein the fixation of the metal plate into the gas fired radiant emitter is such that the metal plate is fixed with play relative to the fixation parts.

7. The gas fired radiant emitter as in claim 1, wherein the burner deck comprises a ceramic burner plate comprising a plurality of perforations for flow of premix gas; or wherein the burner deck comprises metal fibers or a metal wire mesh.

8. The gas fired radiant emitter as in claim 1, wherein the metal plate is retained into the radiant emitter by one or a plurality of retainer bars positioned over and/or below and/or through the metal plate.

9. The gas fired radiant emitter as in claim 8, wherein the one or a plurality of retainer bars contain a hook, wherein the hook grabs through slots in the metal plate to support the bars in retaining the metal plate into the radiant emitter.

10. The gas fired radiant emitter as in claim 8; wherein the metal plate comprises retainer slots along two of its sides, wherein the retainer elements of the frame of the radiant emitter are slid through the retainer slots of the metal plate; or wherein one or a plurality of retainer bars are slid through the retainer slots.

11. The gas fired radiant emitter as in claim 1, wherein the burner deck has a rectangular shape with two parallel long sides and two parallel shorter sides.

12. The gas fired radiant emitter as in claim 11, wherein along the short sides an insulating element is positioned between the burner deck and the metal plate.

13. The gas fired radiant emitter as in claim 11, comprising a sealing element along the short sides such that no flue gas produced by the burner deck can flow out at the short side between the burner deck and the metal plate.

14. The gas fired radiant emitter as in claim 1;
wherein the metal plate comprises a section with increased porosity compared to outside this section;
wherein at the non-combustion side of the metal plate, an ignition device or a sensor is provided at the section with increased porosity.

15. An apparatus for the heat treatment of continuously moving strip material, wherein the apparatus comprises a plurality of gas fired radiant emitters as in claim 1, wherein the gas fired radiant emitters are provided for heat treatment by IR-radiation of the continuously moving strip material.

16. The gas fired radiant emitter as in claim 8, wherein ends of the one or a plurality of retainer bars are positioned through slots in retainer elements of the frame of the radiant emitter.

17. The gas fired radiant emitter as in claim 11, wherein along the long sides, open areas are provided between the burner deck and the metal plate such that flue gas can flow out between the burner deck and the metal plate.

18. The gas fired radiant emitter as in claim 1, wherein the angle between the first tangent and the second tangent is between 75° and 105°.
